(19) United States
(12) Patent Application Publication
(10) Pub. No.: US 2015/0002389 A1
(43) Pub. Date: Jan. 1, 2015

(54) Method for Recognizing a Performed Gesture, Device, User Terminal and Associated Computer Program

(71) Applicant: Orange, Paris (FR)

(72) Inventors: Gregoire Lefebvre, Crolles (FR); Rick Moritz, Grenoble (FR)

(21) Appl. No.: 14/316,287

(22) Filed: Jun. 26, 2014

(30) Foreign Application Priority Data
Jun. 27, 2013 (FR) 1356205

(51) Int. Cl. G06K 9/00; G06K 9/62; G06F 3/01

(52) U.S. Cl. CPC G06K 9/00335; G06F 3/017; G06K 9/6218; G06K 9/6253
USPC 345/156

(57) ABSTRACT

A method of recognizing a gesture made on an instrument. The gesture being performed by a user with a mobile terminal having a plurality of physical measurement sensors. The method includes searching for at least one stored entry corresponding to a pair formed by one of at least one recognized useful gesture and one of at least one recognized usage context; obtaining a corresponding appearance probability per pair, calculated as a function of a number of occurrences on which the pair has been recognized; deciding to confirm a pair as a function of the appearance probability; in the event of not recognizing at least one current usage context, requesting the user to confirm the recognized gesture; if confirmed, storing analyzed physical measurement values as a new usage context and storing a new pair formed by the recognized gesture and the new usage context, with an associated appearance probability.

### 1. FIELD OF THE INVENTION

The field of the invention is that of gesture interactions, and more particularly that of recognizing a gesture made on an instrument, the gesture being performed by a user with the help of a mobile terminal, and being recognized with a usage context of the user being taken into account.

### 2. DESCRIPTION OF THE PRIOR ART

In recent years there has been an explosion of use being made of so-called “natural” interactions. A user can thus control a terminal or a remote station with everyday gestures in order to gain access simply and quickly to information or to a service. These gestures may be performed in two dimensions (2D) such as figures made on a touch screen that are interpreted as commands by the system, or they may be performed in three dimensions (3D), being made in the air, such as a gesture shortcut for activating a function. 3D gestures can be interpreted by sensing the movement of the mobile terminal held in the hand by using inertial sensors (accelerometer, gyro, magnetometer). These are referred to as gestures made on instruments.

In general, such gestures are recognized by comparing characteristics derived from physical measurements collected by the inertial sensors with characteristics of predefined models. A distance criterion is generally used in a characteristics space for classifying an unknown gesture. Such gesture models are conventionally prepared in featureless environments that do not interfere with acquiring or recognizing gestures.

Nevertheless, given the inherently nomadic nature of a mobile terminal, a user will perform such gestures while on the move, in a very wide variety of usage contexts, and that has consequences on how the gesture is performed and on how it is interpreted.

Firstly, the gestures made by the user can be greatly constrained by the surroundings. If the user is sitting in a seat in a cinema, or riding a bicycle, or traveling on a bus, then the user does not have the same freedom of movement nor the same attention that can be given to performing the gesture. As a result the shape and the quality of the user's gesture will inevitably vary as a function of the usage context.

Secondly, the physical constraints associated with the surroundings interfere with the inertial sensors of the user's mobile terminal since they measure physical values of the surroundings. The vibration induced by the movement of the bus or of the bicycle are picked up by the accelerometer together with the user's movements on the mobile terminal. They thus constitute noise when recognizing gestures.

Thirdly, depending on a user's habits, state of mind, desires, stress, or indeed level of experience, the user will produce the “same” gesture in different ways over time. For example, the user will perform gestures more slowly during periods of calm and more quickly and jerkily during movements of stress. A user's expertise in performing gestures will vary over time, so a gesture that was initially jerky will become more fluid little by little. Such variability in the inertial movements of a user over time also interferes with recognizing a gesture.

US patent application No. 2012/0016641 discloses a gesture recognition system having a gesture recognition module that is suitable for recognizing a gesture from a set of predefined gesture models and from a usage context of the user, and that is suitable for identifying the current usage context from a set of predefined usage context models. Knowledge of such a context is used to filter the set of gestures and to retain only a subset that is authorized for the identified context. For example, when the identified context corresponds to the arrival of an incoming phone call, the only gestures that are authorized are those associated with answering, refusing, or indeed transferring the call. Thus, taking account of a particular usage context of the user enables gestures performed by the user in that context to be recognized more simply and more effectively.

### 3. DRAWBACKS OF THE PRIOR ART

A drawback of that system is that it takes account only of an unchanging set of predefined usage context models, which are independent of the personal habits of the user and independent of potential changes in those habits.

### 4. SUMMARY OF THE INVENTION

The invention seeks to improve the situation with the help of a method of recognizing a gesture made on an instrument, performed by a user on a mobile terminal, said terminal including a measurement module having a plurality of physical measurement sensors including inertial navigation sensors.

According to the invention, said method comprises the following steps:
recognizing at least one useful gesture detected by analyzing physical measurements collected by said sensors and by comparing the analyzed measurements with characteristics of gesture models in a gesture database;
recognizing at least one usage context, referred to as the “current” context, by analyzing physical measurements collected by said sensors and by similarity between the analyzed physical measurements and physical measurements of usage contexts previously stored in a context database;
in the event of at least one useful gesture being recognized and of at least one previously stored usage context being recognized, searching for at least one entry corresponding to a pair formed of one of said at least one recognized useful gesture and one of said at least one recognized usage context, said pair being associated with an appearance probability, which probability has been calculated as a function of a number of occurrences on which said pair have been recognized over a past period of time;
in the event of at least one entry being found, deciding to confirm one of said at least one stored pairs at least as a function of the value of the appearance probability that is obtained;
in the event of recognizing at least one useful gesture and not recognizing at least one current usage context, requesting the user to confirm the recognized gesture; and
in the event of user confirmation, storing the analyzed physical measurement values as a new usage context in the context database and storing the new pair formed by the recognized gesture and by the new usage context, in association with an appearance probability that is calculated on the basis of the current occurrence.

With the invention, recognition of the usage context of the gesture performed by the user is based on analyzing the history of such contexts for that user over time by searching for similarities in the user's usage history. No intervention is required on the part of the user for labeling the usage contexts that are analyzed.

Taking account of the user's habits is made possible by storing over time the gesture/usage context pairs that are encountered.

Storing a new context and a new pair over time also makes it possible to take account of changes in the usages of the user. Thus, unlike the prior art, a particular usage context is not associated with a predefined subset of gestures.

The invention relies on an approach that is entirely novel and inventive for recognizing a gesture made by a user on an instrument, which approach consists in searching for a previously-stored reference gesture and usage context pair corresponding to the recognized current gesture and to the recognized current context, and in confirming or rejecting recognition of the current gesture in the current usage context at least as a function of the appearance probability associated with the pair.

Thus, instead of being limited to standardized usage context models for improving recognition of gestures performed by the user, the invention relies on analyzing and storing the history of the user's usages, thus making it possible to recognize gestures performed by the user as a function of personalized usage contexts.

In an aspect of the invention, when a plurality of stored pairs have been found for a given gesture, the method includes a step of selecting pairs for which the associated appearance probability is greater than a first predetermined confidence threshold.

After the user has performed a gesture in a current usage context, a list of a plurality of candidate gestures, and likewise a list of a plurality of candidate usage contexts can be associated therewith.

An advantage is to present a list of stored pairs that is ordered as a function of decreasing value of appearance probability, thus making it possible to submit for confirmation only that or those gesture/context pairs that is/are the most probable.

In another aspect of the invention, when a plurality of stored pairs have been found, the deciding step further includes a substep of evaluating said pairs by comparing them with a second confidence threshold greater than the first.

This second threshold is selected to be sufficiently high to ensure that only one stored pair can pass. Thus, the system can give great confidence to this pair.

In another aspect of the invention, when the appearance probability obtained for said at least one pair is less than the second predetermined threshold, the deciding step further comprises requesting the user to confirm the recognized gesture.

When the system no longer has sufficient confidence in a pair stored in the database, it consults the user. This serves to limit any risk of a making a wrong decision.

In another aspect of the invention, said method includes a step of updating the appearance probability associated with said at least one found pair as a function of the decision taken for the current occurrence.

If a decision is taken to confirm, then the appearance probability of the pair in question is increased. On the contrary, if a decision is taken not to confirm, then the probability is decreased.

An advantage is to cause the appearance probabilities of gesture/usage context pairs to change together with changes in the usages and habits of the user. Thus, the history taken into account by the system changes over time and the appearance probabilities take account of new occurrences of gesture/context pairs.

In another aspect of the invention, the step of recognizing a usage context comprises the following substeps:
making discrete the measurements acquired by the plurality of sensors, a predetermined number of possible discrete values being associated with each sensor;
storing the resulting discrete values in a current usage context matrix having a number of columns equal to the number of sensors and a number of rows equal to the number of measurements taken by a sensor during the predetermined time period;
aligning the measurement values of the current usage context matrix with measurements of a reference matrix stored in memory by applying edit operations to the measurements of said current matrix, each edit operation having an associated edit cost;
calculating a table of alignment costs, the alignment cost of a measurement j of a sensor i being at least a function of a similarity measurement between the measurement j and another measurement of the sensor i, and of the edit cost associated with the edit operation applied to said measurement j; and
selecting the reference usage context for which the reference matrix has obtained the highest alignment costs.

This technique is based on aligning two matrices, a matrix corresponding to the physical measurements of the current usage contexts and a matrix corresponding to the physical measurements of a usage context stored in memory. The technique evaluates the similarity between the two contexts as a function of the cost of the alignment. An advantage of this technique is that, when evaluating similarity, it is capable of taking account of specific features of the measurements from the various sensors, such as for example their physical natures, and to perform alignments on the basis of physical measurements acquired over periods of time having different lengths. This technique also makes it possible to give more weight to some measurements than to others.

In another aspect of the invention, the edit operations belong to the group comprising at least:
inserting a measurement between two successive measurements of the sensor i;
deleting the measurement j; and
substituting the measurement j by another measurement.

This technique consists in causing the current context matrix to change towards a reference context matrix by applying simple edit operations, such as inserting, deleting, and substituting, each being associated with an edit cost. The similarity measurement between two matrices is associated with the overall cost of alignments, the current matrix being increasingly similar to the reference matrix under consideration with decreasing number of edit operations needed for alignment.

In yet another aspect of the invention, the step of recognizing a usage context further comprises the following substeps:
selecting candidate local alignments per sensor in the alignment cost table, the selected candidates having an alignment cost greater than a predetermined threshold;
clustering candidate local alignments for the plurality of sensors in order to form a usage context pattern;
clustering usage context patterns formed from similarity measurements between character matrices in order to form contexts; and
automatically labeling the contexts that are formed.

This clustering technique serves to select a plurality of alignments so as to put them into context pattern clusters. Context patterns are clustered together by similarity and each cluster is represented by a reference pattern having a label that is generated automatically.

The gesture recognition method as described above in various implementations can be performed by a gesture recognition device of the invention.

Such a device comprises the following modules:
a recognition module for recognizing at least one useful gesture detected by comparing the analyzed measurements with the measurements of gesture models in a gesture database;
a recognition module for recognizing at least one usage context, referred to as the “current” context, by similarity of the analyzed physical measurements with the physical measurements of usage contexts previously stored in a context database;
a search module for searching for at least one entry corresponding to a pair formed by a recognized useful gesture and by a recognized usage context, and suitable for being used in recognizing at least one useful gesture and at least one usage context as previously stored;
a module for obtaining an appearance probability for each corresponding pair, said probability having been calculated as a function of a number of occurrences on which said pair has been detected over a past period of time, and suitable for being performed when at least one entry has been found;
a decision-taking module for confirming one of the at least one pairs at least as a function of the value obtained for appearance probability;
in the event of at least one useful gesture being recognized and no current usage context being recognized, a module for requesting (E8₂) user confirmation of the recognized gesture; and
in the event of user confirmation, a storage module (STORE CU) for storing the analyzed physical measurement values as a new usage context in the context database, and a storage module (STORE C) for storing the new pair made up of the recognized gesture and of the new usage context, together with associated appearance probability calculated on the basis of the current occurrence.

The invention also provides an equipment terminal comprising a measurement module having a plurality of physical measurement sensors including inertial navigation sensors, a module for detecting a useful gesture by analyzing physical measurements collected by the inertial navigation sensors, and a module for detecting a usage context by analyzing physical measurements collected by said sensors.

Such a terminal is remarkable in that it includes the above-described gesture recognition device.

The invention also provides a gesture recognition system comprising a usage context database containing stored entries of usage contexts encountered by the user, a gesture/usage context pair database including stored entries of recognized gesture and recognized usage context pairs, an appearance probability being associated with each said pair, and a user terminal of the invention suitable for sending data to said databases and for accessing their entries.

The invention also provides a computer program including instructions for performing steps of a gesture recognition method as described above when the program is executed by a processor. Such a program may use any programming language. It may be downloaded from a communications network and/or it may be stored on a computer readable medium.

Finally, the invention provides a processor-readable data medium optionally incorporated in the gesture recognition device of the invention, possibly removably, and storing a computer program enabling a gesture recognition method as described above to be performed.

The above-mentioned data media may be any entity or device capable of storing the program and readable by an equipment terminal. For example, the media may comprise storage means such as a read only memory (ROM), e.g. a compact disk (CD) ROM, or a microelectronic circuit ROM, or indeed magnetic recording means, e.g. a floppy disk or a hard disk.

Furthermore, the data media may correspond to a transmissible medium such as an electrical or optical signal, suitable for being conveyed via an electrical or optical cable, by radio, or by other means. Programs of the invention may in particular be downloaded from an Internet type network.

### 6. LIST OF FIGURES

Other advantages and characteristics of the invention appear more clearly on reading the following description of a particular implementation of the invention given merely by way of non-limiting illustration and with reference to the accompanying drawings, in which:

FIG. 1 is a diagram showing examples of gestures performed by a user with a mobile terminal in the context of a particular use;

FIG. 2 is a diagram showing a prior art user terminal suitable for recognizing a gesture made on an instrument;

FIG. 3 is a diagrammatic flow chart showing steps of a gesture recognition method in an implementation of the invention;

FIG. 4 shows an example of similarities between usage context between a current usage context A and a reference context B for n physical measurements picked up by sensors;

FIG. 5 is a diagram showing the steps of a similarity algorithm performed to recognize a usage context in an implementation of the invention;

FIG. 6 shows an example of local alignment clusters obtained using the above similarity algorithm;

FIG. 7 shows an example of global alignment clusters obtained using the above similarity algorithm; and

FIG. 8 shows an example of hardware structure for a device for recognizing a gesture made on an instrument in an implementation of the invention.

### 7. DESCRIPTION OF A PARTICULAR IMPLEMENTATION OF THE INVENTION

The general principle of the invention relies on storing pairs over time, each pair being made up of a recognized gesture and a usage context of the gesture, specific to the user, on associating the pair with a probability of that pair appearing, and on using this probability of appearance to confirm recognition of a current gesture in a current usage context.

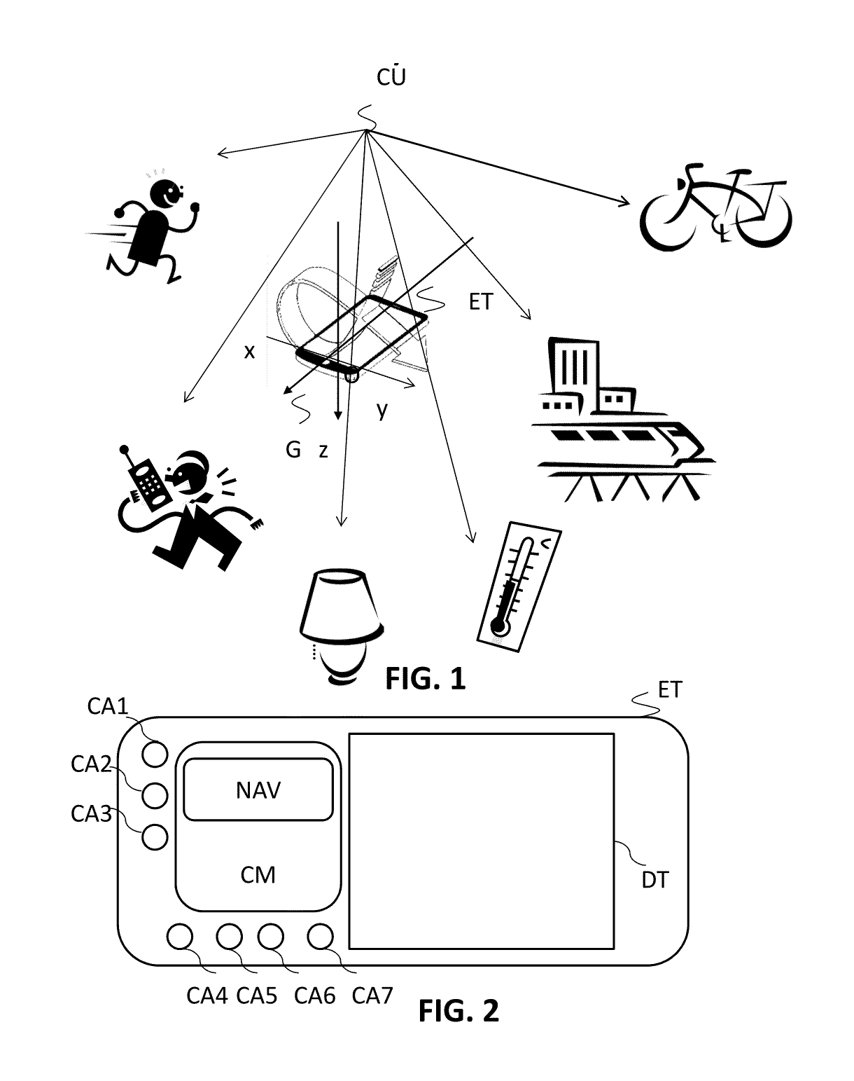

With reference to FIGS. 1 and 2, there is shown an equipment terminal ET, e.g. a mobile telephone of the smartphone type or a tablet, with which a user is performing a gesture G.

The terminal ET is also fitted with a measurement module CM having a plurality of sensors CA1 to CAN for making various physical measurements, where N is an integer, such as for example a light sensor suitable for measuring the intensity of ambient light, a temperature sensor, a microphone suitable for detecting an ambient sound signal, or indeed a locating module of the global positioning system (GPS) type. Among these sensors, the sensors C1 to C3 serve more specifically to collect accelerometer measurements for an inertial navigation module NAV, e.g. incorporated in the module CM.

These three accelerometer sensors CA1 to CA3 are suitable for measuring the linear accelerations of the terminal along three orthogonal axes, a gyro sensor suitable for measuring an angular speed of the terminal ET, and a magnetometer sensor suitable for measuring a magnetic field of the terminal ET. The values of the physical measurements returned by the inertial navigation sensor make it possible to detect and to characterize a gesture G.

The measurements modules CM thus provide the terminal with a set of physical measurement values that can be analyzed in order to characterize a usage context of the terminal, and more particularly a usage context of the gesture G.

In addition, the terminal ET is optionally provided with a touch pad DT.

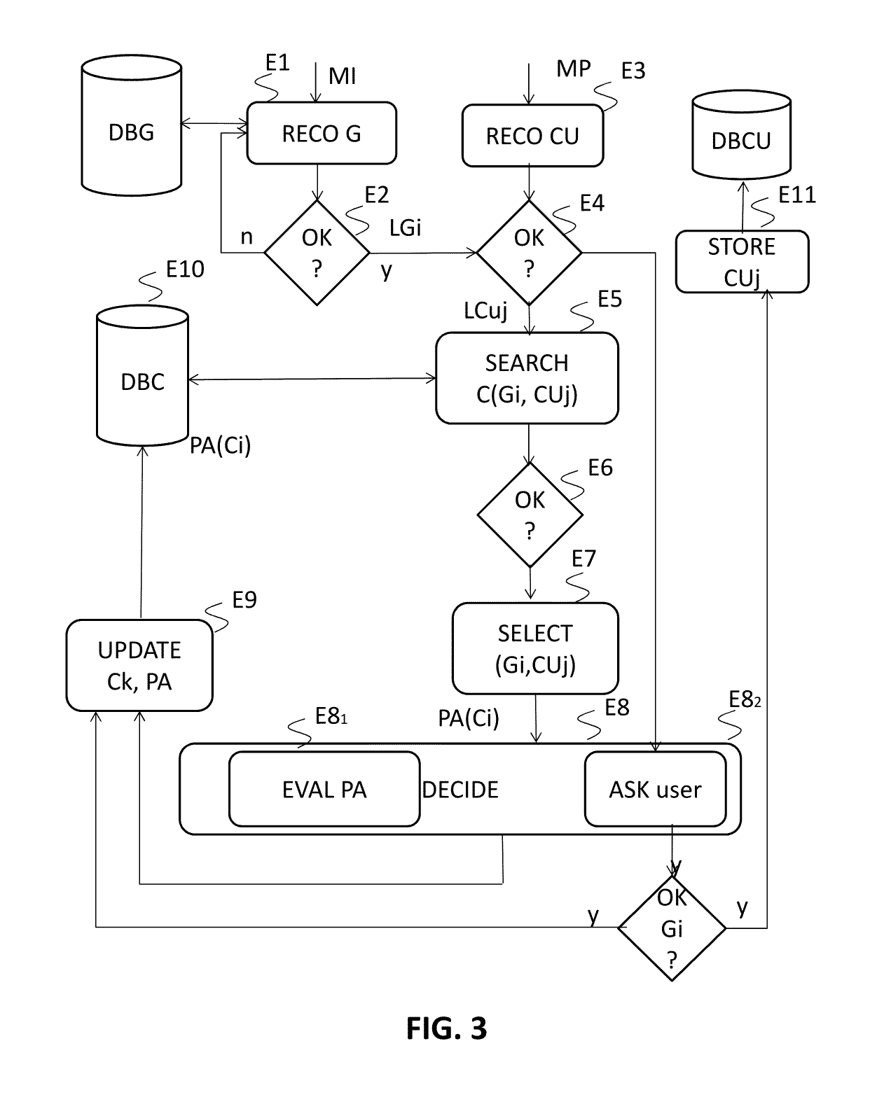

With reference to FIG. 3, there follows a description of the steps of a gesture recognition method in a first implementation of the invention.

It is assumed that the user of the equipment terminal ET begins to perform a gesture G using the terminal. The gesture G is detected by the various inertial navigation sensors that collect physical measurement values during a time interval including the period during which the gesture G is performed.

During a step E1, the gesture G is detected and recognized by analyzing physical measurement values collected by the inertial navigation module of the terminal ET and by comparing them with predefined gesture models that are stored in a reference database DBG of gestures. This step relies on a geometrical approach for classifying an unknown gesture, based on the ten most similar gestures in the reference database on the basis of a distance criterion in the inertial characteristics space. Similarity between two time-varying signals can be measured by using the dynamic time warping (DTW) distance known to the person skilled in the art and described for example in the article by D. H. Wilson et al. entitled “Gesture recognition using the Xwand” published in the technical report of the Robotics Institute of Cornelly Melon University CMU-RI-04-57 in April 2004.

In this embodiment of the invention, it is considered that the gesture G is recognized when the DTW distance measured between its inertial characteristics and the inertial characteristics of at least one reference module in the gesture database is less than a predetermined threshold.

Two situations are possible: if the gesture G is not recognized, then no specific action is performed and the method waits for a new gesture G′ for analysis. It can be understood that the sensors collect physical measurement data continuously and that the gesture recognition step may be triggered at any instant on detecting sufficient activity, e.g. when a detected energy level exceeds a predetermined threshold.

In a first implementation of the invention, it is assumed that the gesture G has been recognized as corresponding to the gesture model G1 in the database DBG. It is thus decided at E2 to give consideration to the usage context in which the user has performed the gesture.

During a step E3, a usage context of the terminal ET is analyzed over a time interval including the period in which the gesture G was performed, on the basis of physical measurement values collected by the sensors. It can thus be understood that this step is performed in parallel with step E1.

The physical measurement values of the context under analysis are compared with values corresponding to usage contexts of the user that have previously been encountered and that are stored in a database DBCU. A stored context is recognized by the similarity between analyzed physical measurements of the current context and of a stored context.

It should be observed that the physical measurements relating to a current usage context need not necessarily have been collected over a time period of duration identical to that of the usage context of the history.

Advantageously, a matrix alignment technique may be used. It is described in greater detail with reference to FIG. 5.

Two situations are possible: either a usage context CU for the current gesture G is recognized at E4 and step E5 is performed, or else no stored usage context is recognized and a deciding step E8 is triggered.

It is assumed that the current usage context CUj has been recognized as corresponding to a stored usage context CU2.

During a step E5, the method searches in a database DBC of gesture/context pairs for a pair corresponding to the current gesture (G1, CU2). Such a database groups together gesture/usage context pairs that have already been recognized in the usage history of the user. It associates a gesture/usage context pair with a probability of appearance PA of that pair, calculated on the basis of the number of occurrences of that pair in the user's history.

Advantageously, such an appearance probability PA is calculated using the following equation:

$$PA = \frac{{nb}_{GiCUj}}{{nb}_{tot}} \qquad ( 1 )$$

where i is a non-zero integer indexing the gesture model and j is a non-zero integer indexing the usage context that has been encountered.

TABLE 1

gesture occurrences

| No. of context | G1 | G2 | G3 | G4 |
|---|---|---|---|---|
| CU1 | 2 | | | |
| CU2 | 3 | 4 | | |
| CU3 | | | | 5 |

In Table 1, it is considered that the number of occurrences of the pair (G1, CU2) is 3 and that the total number nbₜₒₜ of gesture occurrences amounts to 14.

The appearance probability of this pair is calculated using equation (1) giving PA=3/14.

At E6, two situations are possible:
the pair (G1, CU2) is present in the database DBC with an associated appearance probability PA; or
the pair is not present since it has not been encountered before in the user's history.

It is assumed that the pair (G1, CU2) has the greatest probability in the database DBC.

During a step E8, the method takes a decision to confirm or reject the pair (G1, CU2) that has been found. In this implementation, confirmation is automatic if the probability PA(G1,CU2) is greater than a confidence threshold SPA2, or else the user is questioned in E8₂. Advantageously, the threshold is selected to be high enough to ensure that no more than one pair can pass it. Consideration is now given to the situation in which the user is questioned during substep E8₂. If the gesture G1 is confirmed by the user, the number of occurrences of the pair (G1, CU2) under consideration is incremented, e.g. by unity. The probability appearance is recalculated as follows:

$${PA}^{′} ( G 1 , CU 2 ) = \frac{{nb}^{′}}{{nb}_{tot}^{′}} = \frac{r . {b}_{G 1 , CU 2} + 1}{{nb}_{tot} + 1} \qquad ( 2 )$$

In the event of rejection, the appearance probability is recalculated as follows:

$${PA}^{′} ( G 1 , CU 2 ) = \frac{{nb}^{′}}{{nb}_{tot}^{′}} = \frac{{nb}_{G 1 , CU 2}}{r . {b}_{tot} + 1} \qquad ( 3 )$$

Consideration is now given to the situation in which step E1 recognizes a plurality of candidate gestures Gi, where i is an integer.

In E2, the step E3 is triggered and it is considered that it recognizes a plurality of respective usage contexts CUj, where j is an integer.

Step E1 has provided a list LGi of the most probable gestures Gi ordered in decreasing order of the recognition scores they have obtained, with gestures being considered as being recognized if their recognition score is greater than a first recognition threshold SR1 (e.g. 80%) as a function of the database DBG of available reference gestures.

Step E3 provides a list LCuj of the most probable contexts as a function of the current context values and of the history of the user's usage context. This list LCuj, the result of step E2, is taken into account in E4 providing at least one gesture Gi has been recognized.

The step E5 is triggered in E4 when the resulting list LCuj of usage contexts has at least one recognized usage context. This step E5 merges the context and gesture information by:
searching for gesture/context pairs in the list of gestures and the list of contexts that are stored in the pairs database DBC; and
extracting a list LCk of k pairs, where k is an integer, the pairs being ordered in decreasing order on the basis of the appearance probability PA associated with each pair Ck.

During a selection step E7, when a plurality of stored pairs have been found for a given gesture, only those pairs that are associated with an appearance probability PAk greater than a first confidence threshold SPA1 are conserved. For example, this threshold may be selected to about 40%. An advantage of this value is that it eliminates false alarms and avoids subsequently examining pairs that at first sight are not pertinent.

At the end of this selection, the pairs corresponding to the selected gestures are presented to the deciding step E8.

A substep E8₁ of evaluating the appearance probabilities PAk associated with the pairs Ck that have passed the selection step E7 is then performed. It comprises at least comparing the value of PAk with a second predetermined confidence threshold SPA2, e.g. of about 80%. This value is high enough for the system to have confidence in a pair.

If a candidate pair Ck has an appearance probability PAk greater than the threshold, it is automatically confirmed.

Otherwise, if one or more pairs have obtained a score PA that is less than the threshold, two situations are possible:
the selected pairs all relate to the same gesture for a gesture performed in different usage contexts. The system considers that it cannot give sufficient confidence to the candidate pairs. There is therefore ambiguity and it requests confirmation from the user in E8₂. If the user confirms the gesture, the most probable pair Ck is confirmed. If the user does not confirm it, then all of the pairs Ck in question have their appearance probability PAk decreased, e.g. by performing the calculation given by equation (3); or
the selected pairs relate to different gestures. Given that none of the pairs has passed the confidence threshold SPA2, there remains ambiguity about the recognized gesture. This ambiguity needs to be lifted by requesting confirmation from the user during a substep E8₂. Once a gesture has been confirmed by the user, if a plurality of candidate pairs still remain, then the pair Ck that is ultimately selected is the pair that is associated with the greatest value for its appearance probability PAₖ.

Under all circumstances, regardless of whether a pair Ck of the list CLk is confirmed or not, its appearance probability PAₖ is recalculated in E9 as a function of the current occurrence and the decision taken.

Advantageously, the appearance probability PAₖ of a pair Ck is weighted by the decision of the user. For example, consideration may be given to the pair (G1, CU2) that has the highest appearance probability PA, but for which the gesture G1 was rejected by the user. The appearance probability PA of the pair (G1, CU2) is decreased, e.g. in application of equation (3).

In contrast, if the user confirms the proposed decision (G1, CU2) of the system, then the number of occurrences of the pair (G1, CU2) under consideration is increased, e.g. by unity. The appearance probability is recalculated, e.g. in application of equation (2).

Thus, a confirmation decision contributes to reinforcing the appearance probability of this pair and a rejection decision has the effect of decreasing its appearance probability, with a plurality of negative decisions by the user in a row leading to the pair (G1, CU2) being forgotten progressively.

The new value of PA is then updated in the database DBC during a step E10.

It is now assumed that the current context CUcur is not recognized from the database DBCU of usage contexts. Under such circumstances, as mentioned above, the method decides in E4 to switch to the deciding step E8. In E8₂, it submits the recognized gesture Gi for confirmation by the user. If the user confirms that it is indeed the gesture Gi that the user has performed, the new context CUcur is stored as a new context in the database DBCU during a step E11. This new usage context is given an index j′ that has not yet been used, e.g. j′=12, that serves to identify the newly encountered recurrent context. In the invention, it is gesture recognition that is the most important, so it is considered that the gesture Gi has been recognized in the new usage context CUj′. An appearance probability for the new pair Ck′ is calculated during step E9.

In one possible implementation, this appearance probability PAk′ is calculated as being the conditional probability that the gesture G took place in the usage context CU, which is expressed as follows using Bayes' formula:

$$PA ( G ⋂ CU ) = P ( \frac{G}{CU} ) P ( CU ) \qquad ( 4 )$$

The new pair Ck′(Gi,CUj′) is then stored in the database DBC together with its calculated appearance probability PAk′ during step E10.

Otherwise, if the user does not confirm the recognized gesture G, then the new usage context CUj′ is rejected and is not stored in memory.

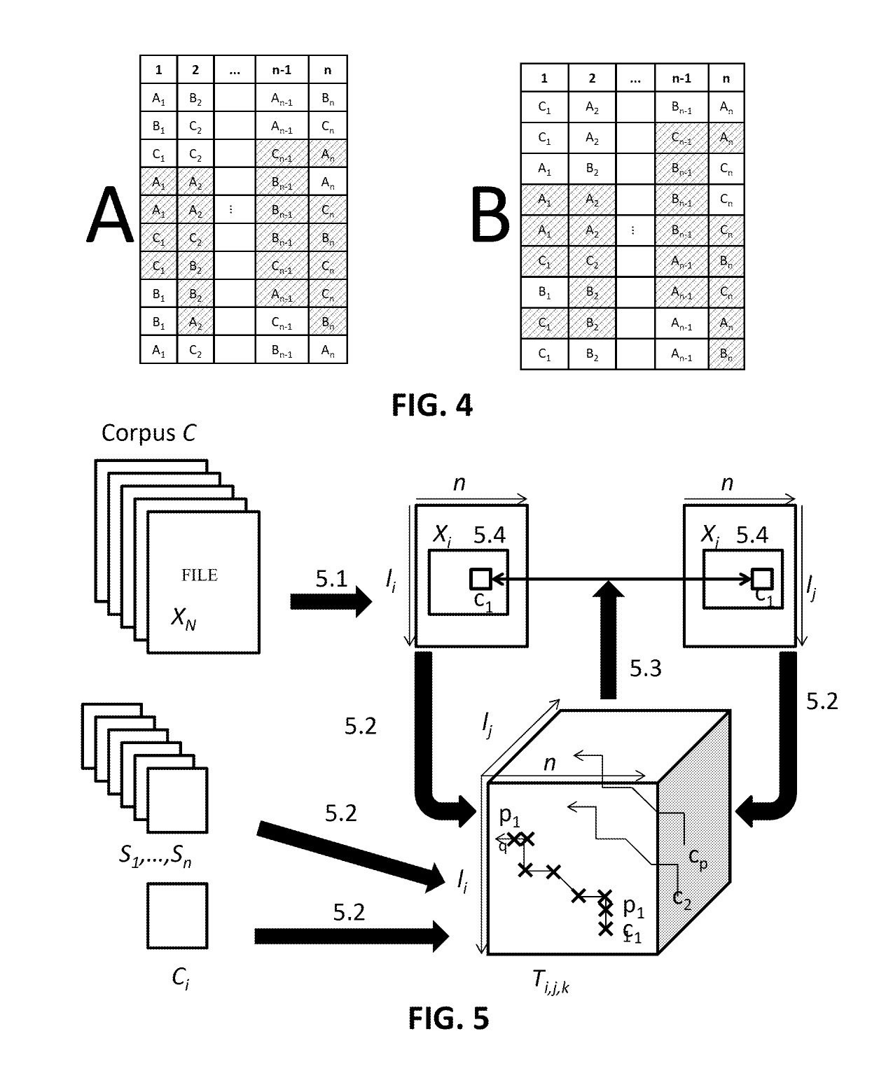

With reference to FIGS. 4 to 7, there follows a description of an example of how the usage context recognition step E3 can be performed in an implementation of the invention.

In this implementation of the invention, the step of recognizing a usage context of the user executes an algorithm for aligning a character matrix on the following principles:

The term “Levenshtein distance” (or edit distance) between two character strings M1 of length L1 and M2 of length L2 is used to designate the minimum cost of reconstituting the string M2 from the characters of the string M1 by performing the following elementary operations:
substituting a character in M1 by a character in M2;
adding in M1 a character from M2; and
deleting a character from M1.

Each of these operations is thus associated with a cost or edit distance. The cost is generally equal to 1. The costs of aligning character strings M1 and M2 are defined by Tᵢⱼ on the basis of the edit costs of these operations, in application of the following pseudo-code:

```
integer Distance (char M1[1...L1], char M2[1...L2])
  for i from 0 to L1
    T[i, 0]:= i
  for j from 0 to L2
    T[0, j]:= j
  D = I = S = 1
  for i from 1 to L1
    for j from 1 to L2
        T[i, j]:= minimum(
                T[i−1, j] + D, // delete
                T[i, j−1] + I, // insert
                T[i−1, j−1] + S // substitute
                )
return T[L1, L2]
```

Thus the value T[L1,L2] gives the distance between the strings of characters M1 and M2.

It should be observed that there is no need for the two character strings to be completely aligned, all that is required is to align at least partially two character matrices between two files representing two periods of the history of a given user. The alignment cost as calculated in this way corresponds to a measurement of similarity such that the greater the measurement, the more the matrices are considered as being similar, and conversely the smaller the measurement, the more the matrices are considered as being dissimilar.

Character strings have only one dimension, length, whereas matrices have two dimensions, being the number of rows and the number of columns. This alignment of character matrices serves to define situations or contexts that resemble each other and to mark these contexts with a label (e.g.: a, b).

With reference to FIG. 5 (i.e. step 5.1), the context data stored for a user is stored in a corpus Corp that is made up of a plurality of files Xᵢ, for i varying from 1 to the number N of files. N is a non-zero integer that is a function of the volume of data that has been acquired and of the length l of each of the files. The value of l has an impact on memory consumption and should therefore be selected as a function of the quantity of memory that is available.

With reference to FIG. 4, each of the N files has a matrix format of n columns and l rows. Each column corresponds to a context variable (e.g. noise, light, location, movement, etc.). The values in the files are not the raw values of the measurements collected by the physical sensors; they have been made discrete. One possible approach for making them discrete is to group together context values measured by physical sensors.

With certain sensors, the values are already available in a discrete state, i.e. the context data about the user's usage is initially labeled on a scale specific to the sensor (e.g. for the light sensor, three levels may be defined: A₁, A₂, A₃) and these sensor labels are ordered on line for each time unit (in this example the acquisition period is 30 seconds).

For each column (and thus sensor) and for each pair of discrete values, a similarity value needs to be defined. These values depend on the type of sensor used to generate the context data. For example, a position sensor provides the physical geographical distance between the locations under study; the additive inverse (i.e. the negative) of the distance may define the similarity between these locations. Thus, increasingly negative similarity values mean that the locations are increasingly dissimilar. The similarity of a location with itself is defined with a positive value. This type of approach is applicable to any sensor possessing a distance measurement (e.g. a light meter, a sound meter, etc.). For other sensors, it is possible to use the probability of transition between two states as a similarity value (i.e. if a sensor often picks up a value x after a value y, the probability of y given knowledge of x can serve as a similarity value. Consequently, the similarity values are grouped together in tables Sᵢ (i from 1 to n) and represent substitution costs between two values of a given sensor.

By way of illustration, consideration is given to the following simplified example:

The user's terminal has two sensors, namely a sensor A suitable for picking up three discrete measurement values A1, A2, and A3, and a sensor B suitable for picking up two discrete values B1, B2.

The similarity values associated with the possible measurement pairs for each of the two sensors are defined in the following tables:

TABLE 2

| S₁ | A1 | A2 | A3 |
|---|---|---|---|
| A1 | 3 | −8 | −5 |
| A2 | −8 | 3 | −8 |
| A3 | −5 | −8 | 4 |

TABLE 3

| S₂ | B1 | B2 |
|---|---|---|
| B1 | 2 | −10 |
| B2 | −10 | 5 |

A table CTᵢ is also used, which defines the costs of inserting or deleting for each state of each sensor; they represent the tendency of a sensor to be synchronized to a greater or lesser extent with the others, and they define a measurement of the impact of a length difference between two otherwise similar intervals.

In the above example, and on the basis of the similarity value it defines, an insertion cost Insi and a deletion cost Deli of a measurement are defined as follows:

Insi(x,y)=Si(x,y)+constant for x< >y (x not equal to y)

Deli(x,y)=Si(x,y)+constant for x< >y

Insi(x,x)=Seli(x,x)=0

For example, the constant may be selected to be equal to −4.

The following table CT, is thus obtained for the edit costs of the operations Inst and Dell on the measurements of the sensor A:

TABLE 4

| CT₁ | A1 | A2 | A3 |
|---|---|---|---|
| A1 | 0 | −12 | −9 |
| A2 | −12 | 0 | −12 |
| A3 | −9 | −12 | 0 |

In the above simplified example, it is desired to align two files F1 and F2 column by column:

TABLE 5
F1

| | | |
|---|---|---|
| 1 | A1 | 1 |
| 2 | A2 | B2 |
| 3 | A2 | B1 |
| 4 | A2 | B1 |
| 5 | A2 | B2 |
| 6 | A3 | B1 |

TABLE 6
F2

| | | |
|---|---|---|
| 1 | A3 | B2 |
| 2 | A2 | B2 |
| 3 | A2 | B1 |
| 4 | A2 | B1 |
| 5 | A1 | B2 |

To find the alignments of the first column between F1 and F2, the following table T is calculated for the string similarity costs for the sensor A. The same is done for the other sensors in order to obtain Tᵢⱼₖ (cf. FIG. 5):

TABLE 7

| T | A3 | A2 | A2 | A2 | A1 |
|---|---|---|---|---|---|
| A1 | 0 | 0 | 0 | 0 | 3 |
| A2 | 0 | 9 | 6 | 3 | 0 |
| A2 | 0 | 9 | 6 | 3 | 0 |
| A2 | 0 | 6 | 6 | 3 | 0 |
| A2 | 0 | 3 | 3 | 3 | 0 |
| A3 | 4 | 0 | 0 | 0 | 0 |

For example, the score T(1,1)=9 corresponds to the accumulated cost of aligning the substrings A2A2A2A1 and A2A2A2A3. These substrings share three values (A2) of similarity S1(A2,A2)=3 (cf. Table 2).

Likewise, T(0,5)=4, since the similarity cost between the substring A3 and A3A2A2A2A1 is S1(A3,A3)=4.

In the general case where n is strictly greater than 2, in order to find the local alignments of character matrices between two files Xᵢ and Xⱼ, a three-dimensional cost table T_{i,j,k}ε [symbol] ^{l}^{ᵢ}^{×l}^{ⱼ}^{×n} is calculated (cf. FIG. 5, step 5.2). This table is generated iteratively from the cell of the table (0,0,0), initially in the column dimension and then in the row dimensions. Each value of T_{i,j,k} is based on the maximum value of the boxes in five directions:
(0,0,−1)
(−1,0,0)
(0,−1,0)
(−1,−1,0)
(−1,−1,−1).

The directions 1, 4, and 5 correspond to substitutions Sₖ(Xᵢ(i,k),Xⱼ(j,k)) (with the various predecessors in T_{i,jk}) and the directions 2 and 3 correspond to a deletion Cₖ(Xᵢ(i,k), Xⱼ(j,k)) at Xᵢ and an insertion Cₖ(Xᵢ(i,k), Xⱼ(j,k)) at Xⱼ, respectively.

The table of costs for aligning the character matrices Xᵢ and Xⱼ is defined by the following pseudo-code:

```
integer Calcul_Tijk (char Xi[1...n] × [1...L1], char Xj[1...n] [1...L2])
T[0, 0, 0]:= 0
for i from 1 to L1
    for j from 1 to L2
    for k from 1 to n
        T[i, j, k]:= maximum(0;
          T[i−1,j,k] + Cₖ(Xi(i,k),Xj(j,k)), //delete
          T[i,j−1,k] + Cₖ(Xi(i,k),Xj(j,k)), //insert
          T[i,j,k−1] + Sₖ(Xi(i,k),Xj(j,k)), //substitute
          T[i−1,j−1,k] + Sₖ(Xi(i,k),Xj(j,k)), //substitute
          T[i−1,j−1,k−1] + Sₖ(Xi(i,k),Xj(j,k)), //substitute
                  )
```

It can be understood that at that the position (i,j,k) the alignment costs correspond to the maximum from among the following values:
0;
the sum of the cost T obtained at the position (i−1,j,k) plus the associated cost of deletion between Xi(i,k) (element of the file Xi at row i for the sensor k) and Xj(j,k) (element of the file Xj at row j for sensor k);
the sum of the cost T obtained at the position (i,j−1,k) plus the associated cost of insertion between Xi(i,k) and Xj(j,k);
the sum of the cost T obtained at the position (i,j,k−1) plus the cost of the associated substitution between Xi(i,k) and Xj(j,k);
the sum of the cost T obtained at the position (i−1,j−1,k) plus the cost of the associated substitution between Xi(i,k) and Xj(j,k); and
the sum of the cost T obtained at the position (i−1,j−1,k−1) plus the cost of the associated substitution between Xi(i,k) and Xj(j,k).

The following step 5.3 consists in finding candidates for the alignments. These candidates are those that have a high accumulated alignment cost in T_{i,j,k}. More precisely, the positions in T_{i,j,k} are designated as candidates {z₁, . . . , zₚ} for a trace-back algorithm, if their values are:

a) greater than the 26 adjacent values in the 3D space of the indices of T_{i,j,k}; and

b) greater than a threshold THLD that is based on the minimum size desired for an alignment.

Starting from these candidate positions, the trace-back follows a path in T_{i,j,k} in the five above-described directions to a zero value (or a boundary of the costs table), showing that alignment has ended. Each position passed through in this way forms part of the alignment between X, and X: the pivots {p₁₁, . . . , p_{1q}} (e.g. the pivot p₁₂=T_{i=5,j=2,k=3} put into correspondence the sensor 3 for the row 5 of Xᵢ and for the row 2 of Xⱼ, i.e. these two items of context information are aligned). The original candidates form part of the set of pivots.

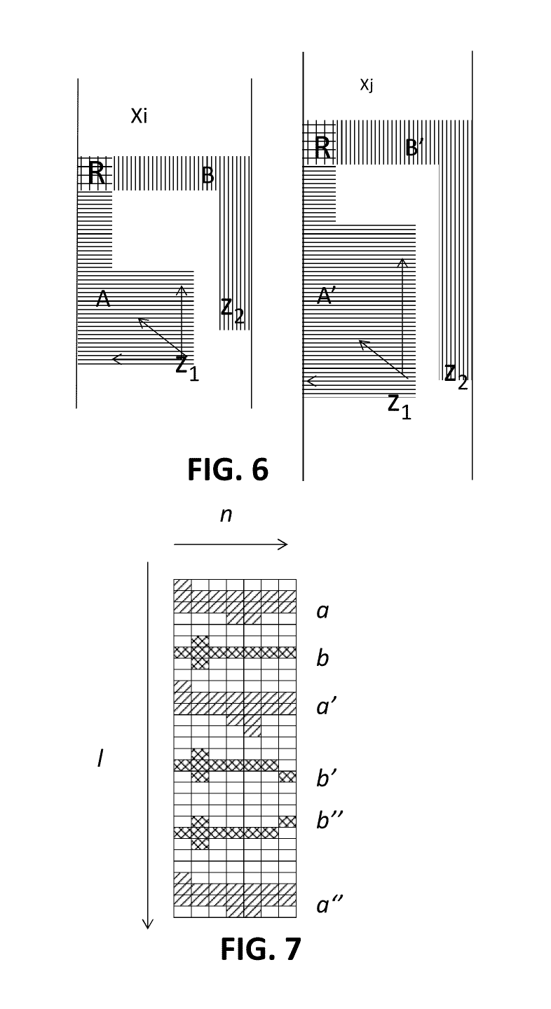

The set of pivots forms an alignment effected in 5.4. With reference to FIG. 6, two alignments are formed: A with A′ and B with B′. A and B are merged since they are considered as representing the same usage context pattern, on the basis of a geometrical criterion, which is sharing a common root R.

The resulting clusters are then labeled.

In order to group together the various context patterns of the overall corpus Corp, it is necessary to use an algorithmic clustering approach (e.g. in FIG. 7, the portions a, a′, and a″ are similar patterns describing the same context). Clustering algorithms are conventionally based on a measure of similarity. In the implementation under consideration, this measure is the measure of similarity between two matrices of characters, as described above. For each cluster, a representative is created by selecting the element having the greatest similarity value relative to all of the other elements in the cluster (i.e. the centroid). This element is used for determining the measure of similarity between contexts as determined in real time and known contexts; if this measure is greater than a threshold, the current context is recognized as being the ordinary context as represented by the cluster of alignment from which the representative comes.

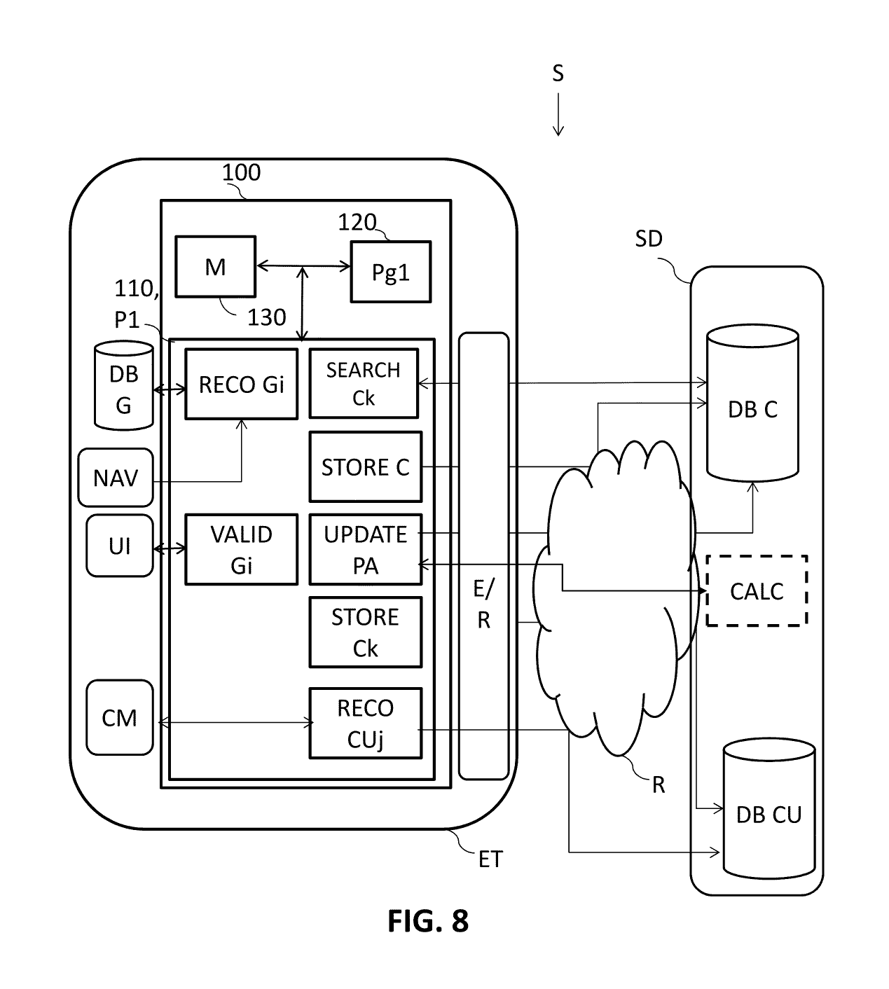

With reference to FIG. 8, consideration is given below to a simplified structure of a device 100 for recognizing a gesture made on an instrument and constituting an embodiment of the invention. The device 100 performs the recognition of the invention as described above.

It should be observed that the above-described invention is suitable for being performed using software and/or hardware components. Consequently, the terms “module” and “entity” as used in this document, may correspond either to a software component or to a hardware component or indeed to a set of hardware and/or software components, suitable for performing the function(s) described for the module or entity under consideration.

In this example, the device 100 is incorporated in an equipment terminal ET of a user. In a variant, the device 100 could be independent and could be connected to the terminal ET.

For example, the device 100 comprises a processor unit 110 having for example a processor P1 and controlled by a computer program Pg₁ 120 that is stored in a memory 130 and that performs the recognition method of the invention.

On initialization, code instructions of the computer program Pg₁ 120 are loaded for example into a RAM prior to being executed by the processors of the processor unit 110. The processor of the processor unit 110 performs the steps of the above-described recognition method using instructions of the computer program 120. In the embodiment of the invention under consideration, the device 100 comprises at least: a unit RECO Gi for recognizing the gesture Gi performed by the user; a unit RECO CUj for recognizing the current usage context in which the user performed the gesture Gcur; a unit SEARCH for searching a list of pairs Ck(Gi,CUj) made up of recognized current gestures and usage contexts; a unit SEL for selecting pairs from the resulting list Lk; a unit VALID for deciding to confirm or to reject selected pairs Ck; a unit UPDATE for updating an appearance probability PA associated with the pair Ck as a function of the decision taken; a unit STORE CU for storing new analyzed current contexts when no usage context stored in a database DBCU is recognized; and a unit STORE C for storing the pair made up of the recognized gesture and the new usage context when none of the pairs stored in the pairs database DBC has been recognized. These units are controlled by the processor P1 of the processor unit 110.

The gesture recognition device 100 is thus arranged to co-operate with the terminal ET, and in particular with the following modules of the terminal: an inertial navigation module NAV suitable for measuring a vector of inertial characteristics at an instant tₙ and for making it available to the gesture recognition unit RECO G; a user interaction module UI suitable for being interrogated by the unit VALID in order to request confirmation from the user; a module CM for collecting physical measurements made by a plurality of sensors arranged on the terminal ET; and a database storing models of gestures for use by the gesture recognition unit.

In a possible implementation, the context database DBCU and the pairs database DBC are stored on a remote server SD, e.g. dedicated to storing context information and to calculating appearance probabilities associated with the pairs Ck(Gi,CUj) that are encountered. Such a remote server is connected to a network IP, e.g. the Internet. The user terminal ET is suitable for collecting the physical measurements from the sensors and for transferring them to the device 100 so that it can analyze them. The terminal ET is also suitable for transmitting data relating to the analyzed usage context and to the identified gesture/usage context pairs to the remote server SD via the network R so that it can store them in the corresponding database. Finally, the terminal ET is suitable for interrogating the databases DBCU and DBC in order to obtain the information required by the device 100.

This ensures that the needs of the equipment terminal ET in terms of calculation power, of storage memory, and of energy remain limited.

Consideration is also given to a gesture recognition system S of the invention. In this implementation, it comprises the terminal ET, the device 100, and the server SD hosting the usage context and the pairs databases.

The invention as descried above has numerous applications. In particular it may be used to recognize more effectively and more robustly a gesture made on an instrument in association with a particular action, for example running an application on the user's terminal, accessing a menu, confirming an option, etc.

By way of example, the following usages may be considered:
a user is in the metro and seeks to call a contact by making a circular gesture. The shaking of the metro prevents the gesture being properly recognized, but recognition of the usage context with the help of sound sensors and of the inertial navigation module (noisy plus considerable shaking) makes it possible to identify a usage context that has been met in the past:
a user seeks to take a photograph of his daughter on a bicycle in a park. He makes a square-shaped gesture to launch the “camera” application. He needs to act quickly in order not to miss this memorable instant so he performs the gesture with hurried inaccuracy. This affects gesture recognition. However recognition of the usage context on the basis of a light sensor, a microphone, and a GPS module for example, serves to recognize the context in the user's history. In the past, the user has already made a square in this usage situation. With the invention, the system is capable of confirming the gesture as being a square even though it was performed less accurately than usual, because it takes account of the user's usage context, and therefore triggers activation of the camera.

1. A method of recognizing a gesture made on an instrument, performed by a user on a mobile terminal, said terminal including a measurement module having a plurality of physical measurement sensors including inertial navigation sensors, said method comprising the following steps:
recognizing at least one useful gesture detected by analyzing physical measurements collected by said sensors and by comparing the analyzed measurements with characteristics of gesture models in a gesture database;
recognizing at least one usage context, referred to as the “current” context, by analyzing physical measurements collected by said sensors and by similarity between the analyzed physical measurements and physical measurements of usage contexts previously stored in a context database;
in the event of at least one useful gesture being recognized and of at least one previously stored usage context being recognized, searching for at least one entry corresponding to a pair formed of one of said at least one recognized useful gesture and one of said at least one recognized usage context, said pair being associated with an appearance probability, which probability has been calculated as a function of a number of occurrences on which said pair have been recognized over a past period of time;
in the event of at least one entry being found, deciding to confirm one of said at least one stored pairs at least as a function of the value of the appearance probability that is obtained;
in the event of recognizing at least one useful gesture and not recognizing at least one current usage context, requesting the user to confirm the recognized gesture; and
in the event of user confirmation, storing the analyzed physical measurement values as a new usage context in the context database and storing the new pair formed by the recognized gesture and by the new usage context, in association with an appearance probability that is calculated on the basis of the current occurrence.

2. A method of recognizing a gesture according to claim 1, wherein when a plurality of stored pairs have been found for a given gesture, the method includes a step of selecting pairs for which the associated appearance probability is greater than a first predetermined confidence threshold.

3. A method of recognizing a gesture according to claim 1, wherein when a plurality of stored pairs have been found, the deciding step further includes a substep of evaluating said pairs by comparing them with a second predetermined confidence threshold.

4. A method of recognizing a gesture according to claim 3, wherein when the appearance probability obtained for said at least one pair is less than the second predetermined threshold, the deciding step further comprises requesting the user to confirm the gesture of said at least one pair.

5. A method of recognizing a gesture according to claim 1, wherein said method includes a step of updating the appearance probability associated with said at least one found pair as a function of the decision taken for the current occurrence.

6. A method of recognizing a gesture according to claim 1, wherein the step of recognizing a usage context comprises the following substeps:
making discrete the measurements acquired by the plurality of sensors, a predetermined number of possible discrete values being associated with each sensor;
storing the resulting discrete values in a current usage context matrix having a number of columns equal to the number of sensors and a number of rows equal to the number of measurements taken by a sensor during the predetermined time period;
aligning the measurement values of the current usage context matrix with measurements of a reference matrix stored in memory by applying edit operations to the measurements of said current matrix, each edit operation having an associated edit cost;
calculating a table of alignment costs, the alignment cost of a measurement of a sensor being at least a function of a similarity measurement between the measurement and another measurement of the sensor i, and of the edit cost associated with the edit operation applied to said measurement; and
selecting the reference usage context for which the reference matrix has obtained the highest alignment costs.

7. A method of recognizing a gesture according to claim 6, wherein the edit operations belong to the group comprising at least:
inserting a measurement between two successive measurements of the sensor;
deleting the measurement; and
substituting the measurement by another measurement.

8. A method of recognizing a gesture according to claim 6, wherein the step of recognizing a usage context further comprises the following substeps:
selecting candidate local alignments per sensor in the alignment cost table, the selected candidates having an alignment cost greater than a predetermined threshold;
clustering candidate local alignments for the plurality of sensors in order to form a usage context pattern;
clustering usage context patterns formed from similarity measurements between character matrices in order to form contexts; and
automatically labeling the contexts that are formed.

9. A device for recognizing a gesture on an instrument, the gesture being performed by a user with the help of a mobile terminal, said terminal including a measurement module having a plurality of physical measurement sensors including inertial navigation sensors, said device comprising the following units:
a recognition unit configured to recognize at least one useful gesture detected by analyzing physical measurements collected by said sensors and by comparing the analyzed measurements with characteristics of gesture models in a gesture database;
a recognition unit configured to at least one usage context, referred to as the “current” context, by analyzing physical measurements collected by said sensors and by similarity between the analyzed physical measurements and physical measurements of usage contexts previously stored in a context database;
in the event of at least one useful gesture being recognized and of at least one previously stored usage context being recognized, a search unit for searching for at least one entry corresponding to a pair formed of one of said at least one recognized useful gesture and one of said at least one recognized usage context, said pair being associated with an appearance probability, which probability has been calculated as a function of a number of occurrences on which said pair have been recognized over a past period of time;
in the event of at least one entry being found, a decision-taking unit for confirming one of said at least one stored pairs at least as a function of the value of the appearance probability that is obtained;
in the event of recognizing at least one useful gesture and not recognizing at least one current usage context, requesting the user to confirm the recognized gesture; and
in the event of user confirmation, a storage unit for storing the analyzed physical measurement values as a new usage context in the context database and a storage unit for storing the new pair formed by the recognized gesture and by the new usage context, in association with an appearance probability that is calculated on the basis of the current occurrence.

10. A user terminal comprising:
a plurality of physical measurement sensors including inertial navigation sensors; and
a device for recognizing a gesture on an instrument, the gesture being performed by a user with the help the user terminal, said device comprising the following units:
a recognition unit configured to recognize at least one useful gesture detected by analyzing physical measurements collected by said sensors and by comparing the analyzed measurements with characteristics of gesture models in a gesture database;
a recognition unit configured to at least one usage context, referred to as the “current” context, by analyzing physical measurements collected by said sensors and by similarity between the analyzed physical measurements and physical measurements of usage contexts previously stored in a context database;
in the event of at least one useful gesture being recognized and of at least one previously stored usage context being recognized, a search unit for searching for at least one entry corresponding to a pair formed of one of said at least one recognized useful gesture and one of said at least one recognized usage context, said pair being associated with an appearance probability, which probability has been calculated as a function of a number of occurrences on which said pair have been recognized over a past period of time;
in the event of at least one entry being found, a decision-taking unit for confirming one of said at least one stored pairs at least as a function of the value of the appearance probability that is obtained;
in the event of recognizing at least one useful gesture and not recognizing at least one current usage context, requesting the user to confirm the recognized gesture; and
in the event of user confirmation, a storage unit for storing the analyzed physical measurement values as a new usage context in the context database and a storage unit for storing the new pair formed by the recognized gesture and by the new usage context, in association with an appearance probability that is calculated on the basis of the current occurrence.

11. (canceled)

12. A non-transitory processor readable storage medium having stored thereon a computer program including instructions for performing steps of a method of recognizing a gesture made on an instrument, performed by a user on a mobile terminal, when executed by a processor, said terminal including a measurement module having a plurality of physical measurement sensors including inertial navigation sensors, said method comprising the following steps:
recognizing at least one useful gesture detected by analyzing physical measurements collected by said sensors and by comparing the analyzed measurements with characteristics of gesture models in a gesture database;
recognizing at least one usage context, referred to as the “current” context, by analyzing physical measurements collected by said sensors and by similarity between the analyzed physical measurements and physical measurements of usage contexts previously stored in a context database;
in the event of at least one useful gesture being recognized and of at least one previously stored usage context being recognized, searching for at least one entry corresponding to a pair formed of one of said at least one recognized useful gesture and one of said at least one recognized usage context, said pair being associated with an appearance probability, which probability has been calculated as a function of a number of occurrences on which said pair have been recognized over a past period of time;
in the event of at least one entry being found, deciding to confirm one of said at least one stored pairs at least as a function of the value of the appearance probability that is obtained;
in the event of recognizing at least one useful gesture and not recognizing at least one current usage context, requesting the user to confirm the recognized gesture; and
in the event of user confirmation, storing the analyzed physical measurement values as a new usage context in the context database and storing the new pair formed by the recognized gesture and by the new usage context, in association with an appearance probability that is calculated on the basis of the current occurrence.

13. (canceled)
